(19) United States
(12) Patent Application Publication
(10) Pub. No.: US 2011/0244389 A1
(43) Pub. Date: Oct. 6, 2011

(54) FERRITE CARRIER CORE MATERIAL FOR ELECTROPHOTOGRAPHIC DEVELOPER, FERRITE CARRIER FOR ELECTROPHOTOGRAPHIC DEVELOPER AND METHODS FOR PRODUCING THE FERRITE CARRIER CORE MATERIAL AND THE FERRITE CARRIER, AND ELECTROPHOTOGRAPHIC DEVELOPER USING THE FERRITE CARRIER

(75) Inventors: Takashi KOJIMA, Kashiwa-shi (JP); Tetsuya UEMURA, Kashiwa-shi (JP)

(73) Assignee: POWDERTECH CO., LTD., Chiba (JP)

(21) Appl. No.: 13/071,887

(22) Filed: Mar. 25, 2011

(30) Foreign Application Priority Data
Mar. 30, 2010 (JP) 2010-078555
Dec. 28, 2010 (JP) 2010-293662

(51) Int. Cl. G03G 9/08

(52) U.S. Cl. 430/111.1; 430/137.1; 430/137.13

(57) ABSTRACT

Disclosed are a ferrite carrier core material for an electrophotographic developer including a ferrite particle having an apparent density of 2.30 to 2.80 g/cm³, a BET specific surface area of 0.09 to 0.70 m²/g and an average degree of circularity of 0.90 or more, wherein the Cl concentration of the ferrite carrier core material measured by an elution method is 0.1 to 100 ppm, a ferrite carrier for an electrophotographic developer obtained by coating the surface of the ferrite carrier core material with a resin, and methods for producing the ferrite carrier core material and the ferrite carrier, and an electrophotographic developer using the ferrite carrier.

### BACKGROUND OF THE INVENTION

1. Field of the Invention

The present invention relates to a ferrite carrier core material and a ferrite carrier obtained by coating the surface of the ferrite carrier core material with a resin, both used in a two-component electrophotographic developer used in apparatuses such as copiers and printers, and methods for producing the ferrite carrier core material and the ferrite carrier, and specifically relates to a ferrite carrier core material for an electrophotographic developer and a ferrite carrier for an electrophotographic developer, capable of providing a stable intended charge amount and small in environmental variations of the electric properties including the charge amount, and methods for producing the ferrite carrier core material and the ferrite carrier, and an electrophotographic developer using the ferrite carrier.

2. Description of the Related Art

An electrophotographic development method is a method in which development is performed by adhering the toner particles in a developer to the electrostatic latent image formed on a photoreceptor, and the developer used in such a method is classified into a two-component developer composed of toner particles and carrier particles and a one-component developer using only toner particles.

As a development method using, among such developers, a two-component developer composed of toner particles and carrier particles, previously a method such as a cascade method has been adopted, but currently a magnetic brush method using a magnet roll predominates.

In a two-component developer, the carrier particles serve as a carrying substance to form a toner image on the photoreceptor in such a way that the carrier particles are stirred together with the toner particles in a developer box filled with the developer to impart an intended charge to the toner particles, and further, convey the thus charged toner particles to the surface of the photoreceptor to form the toner image on the photoreceptor. The carrier particles remaining on a development roll which holds a magnet again return from the development roll into the developer box to be mixed and stirred with the fresh toner particles and to be repeatedly used for a predetermined period of time.

In contrast to a one-component developer, a two-component developer is such that the carrier particles are mixed and stirred with the toner particles, thus charge the toner particles, and further have a function to convey the toner particles, and a two-component developer is excellent in the controllability in designing developers. Accordingly, two-component developers are suitable for apparatuses such as full-color development apparatuses required to offer high image quality and high-speed printing apparatuses required to be satisfactory in the reliability and durability in image maintenance.

In such two-component developers as described above, the image properties such as the image density, fogging, white spots, gradation and resolution are each required to exhibit a predetermined value from the initial stage, and further these properties are required to be invariant and to be stably maintained during the endurance printing. For the purpose of stably maintaining these properties, the properties of the carrier particles contained in the two-component developers are required to be stable.

As the carrier particles which form two-component developers, there have hitherto been used iron powder carriers such as an iron powder carrier in which the surface of an iron powder is coated with an oxide film or an iron powder carrier in which the surface of an iron powder is coated with a resin. Such iron powder carriers are high in magnetization and also high in conductivity, and hence have an advantage that images satisfactory in the reproducibility of the solid print portions thereof are easily obtained.

However, the true specific gravities of such iron powder carriers are as heavy as about 7.8, and the magnetizations of such iron power carriers are too high. Accordingly, the stirring and mixing of such an iron powder carrier with the toner particles in the developer box tend to cause the fusion bonding of the toner-constituting components to the surface of the iron powder carrier, namely, the so-called toner spent. The occurrence of such a toner spent reduces the effective surface area of the carrier, and the triboelectric charging ability of the carrier in relation to the toner particles tends to be degraded.

Additionally, in the resin-coated iron powder carrier, the resin on the surface is exfoliated by the stress at the time of endurance operation to expose the core material (iron powder) which is highly conductive and low in dielectric breakdown voltage, and accordingly the charge leakage occurs as the case may be. Such charge leakage breaks the electrostatic latent image formed on the photoreceptor, causes brush strokes or the like to occur on the solid print portion, and makes it difficult to obtain a uniform image. Due to these reasons, currently the iron powder carriers such as oxide-coated iron powder carriers and resin-coated iron powder carriers have gradually fallen into disuse.

In recent years, in place of the iron powder carriers, ferrite particles each having a true specific gravity of as light as about 5.0 and being low in magnetization have been used as carriers, and resin-coated carriers in each of which the surface of the ferrite particles is further coated with a resin have been frequently used, and accordingly the operating lives of the developers have been dramatically extended.

Japanese Patent Laid-Open No. 8-22150 proposes a ferrite carrier for an electrophotographic developer in which as the composition of the ferrite particle, a composition in which a manganese-magnesium ferrite is partially substituted with strontium is used.

The method for producing the ferrite carrier is as follows: ferrite raw materials are pulverized, mixed together and pelletized, and then calcined; then, the resulting calcined substance was pulverized and slurried, the viscosity of the slurry was regulated, the slurry was granulated, and the resulting granulated substance is subjected to final sintering; the sintered substance is pulverized and regulated with respect to the particle size; the surface of the obtained ferrite particles is coated with a resin. The final sintering is performed at a sintering temperature of 1000 to 1500° C. by using a batch electric furnace or a rotary electric furnace. In this manner, conventional production methods require long production steps.

In such a production method as described in Japanese Patent Laid-Open No. 8-22150, the production steps are long to lead to a disadvantage with respect to the production stability, and additionally, the obtained ferrite carrier hardly attains an intended stable charging property, is large in the environmental variations of the electric properties including the charging property, and cannot respond to the recent demand such that the environmental variation of the charge amount is to be made extremely small while the charge amount is high. In particular, recently frequently used polymerized toners and low-temperature fixing toners often cause problems such that such toners are comparatively lower in charge amount and larger in the environmental variation of the charge amount as compared to conventional toners. When combined with these toners, such a ferrite carrier as described above is far from satisfactorily attaining an intended high charge amount and additionally far from sufficiently suppressing the environmental variation.

Because of the current trend to encourage color printing and high-speed printing, high toner concentration and high-speed development are required; under such conditions, the carriers are required to be markedly higher and more stable in chargeability than conventional carriers; however, the above-described ferrite carriers are far from satisfying these requirements.

On the other hand, as a method for producing a true sphere-shaped ferrite carrier core material or ferrite carrier, a method in which ferrite raw materials are sintered by thermal spraying has been proposed. Japanese Patent Laid-Open No. 2008-249855 describes a resin-coated ferrite carrier for an electrophotographic developer in which the BET specific surface area and the apparent density of the ferrite carrier core material are 900 to 5000 cm²/g and 2.30 to 2.80 g/cm³, respectively. The ferrite carrier core material is described to be obtained as follows: the granulated substance obtained by preparing the raw materials of the ferrite carrier are thermally sprayed in the air to be ferritized, and successively the resulting ferritized substance is rapidly cooled and solidified to yield the ferrite carrier core material.

With this production method, a ferrite carrier core material falling within certain ranges with respect to the BET specific surface area and the apparent density is obtained, but such a ferrite carrier core material does not provide any solution to a problem such that it is difficult to obtain the intended stable charging property, and additionally the environmental variations of the electric properties including the charging property are large.

Japanese Patent Laid-Open No. 2008-250214 describes a method for producing a carrier core material, wherein: raw material powders are weighed out and mixed together, and water is added to the resulting mixture to form a slurry; the slurry is granulated by spray drying to prepare particles of a precursor; the particles are sintered to prepare a sintered substance; the sintered substance is heat treated by making the sintered substance fall into the flame at 2000° C. or higher or by dispersing the sintered substance in a combustion flame to form stripe raised portions on the surface of the particles; and then the particles are classified with a sieve. It is stated that in the formation of the slurry, addition of a binder to water is effective, and polyvinyl alcohol is preferable as the binder.

Additionally, Japanese Patent Laid-Open No. 2009-244572 describes a method for producing a carrier core material for an electrographic developer, wherein a granulated substance obtained by preparing the raw materials of the carrier core material together with a binder is subjected to thermal spraying in the air to be ferritized, and then the ferritized substance is rapidly cooled and solidified to yield the carrier core material. Examples of the binder to be used in this case include polyvinyl alcohol and polyvinyl pyrrolidone.

In Japanese Patent Laid-Open Nos. 2008-250214 and 2009-244572, carrier core materials are each produced by using the raw materials of the carrier core material together with a binder, but such carrier core materials do not provide a solution to a problem such that it is difficult to obtain the intended stable charging property, and additionally the environmental variations of the electric properties including the charging property are large.

On the other hand, Japanese Patent Laid-Open No. 2006-267345 describes a two-component developer using a carrier which has a coating layer on a ferrite particle and contains a certain amount of the chlorine element in relation to the iron element. Japanese Patent Laid-Open No. 2006-267345 pays attention to the presence of the trace elements contained in the carrier and the effects thereof, and in particular, pays attention to the fact that the chlorine element in the ferrite particle affects the durability of the carrier, and shows that: the control of the amount of the chlorine element improves the hardness of the ferrite and develops a tough durability in the ferrite so as for the ferrite not to be chipped even when a load is applied; the polar effect of the chlorine element improves the adhesion between the ferrite surface and the resin coating layer, and consequently the resin coating layer is not easily exfoliated.

As described above, Japanese Patent Laid-Open No. 2006-267345 shows that the resin coating layer is not easily exfoliated due to the presence of the chlorine element on the surface of the ferrite carrier core material, but does not describe anything about the fact that the presence of the chlorine element affects the charge amount. Additionally, by merely specifying the amount of the chlorine element present on the surface of the ferrite carrier core material, it is impossible to solve the problem that it is difficult to obtain the intended stable charging property, and additionally the environmental variations of the electric properties including the charging property are large.

As described above, there have been demanded a ferrite carrier core material for an electrophotographic developer capable of obtaining an intended stable charge amount and small in the environmental variations of the electric properties including the charge amount and a ferrite carrier obtained by coating the surface of the ferrite carrier core material with a resin.

### SUMMARY OF THE INVENTION

Under the above-described circumstances, an object of the present invention is to provide a ferrite carrier core material for an electrophotographic developer and a ferrite carrier for an electrophotographic developer, capable of obtaining an intended stable charge amount and additionally small in the environmental variations of the electric properties including the charge amount, and methods for producing the ferrite carrier core material and the ferrite carrier, and an electrophotographic developer using the ferrite carrier.

For the purpose of solving the above-described problems, the present inventors made a diligent study and consequently reached the present invention by finding that the above-described object can be achieved by a ferrite carrier core material in which the apparent density, the BET specific surface area and the average degree of circularity fall within specified ranges and the Cl concentration is suppressed so as to fall within a certain range, and additionally by discovering that such a ferrite carrier core material is obtained by granulating a binder having specific properties and conditions together with the raw materials of the carrier core material and by thermally spraying the resulting granulated substance in the air and by rapidly cooling and solidifying the resulting thermally sprayed substance.

Specifically, the present invention provides a ferrite carrier core material for an electrophotographic developer, including a ferrite particle having an apparent density of 2.30 to 2.80 g/cm³, a BET specific surface area of 0.09 to 0.70 m²/g and an average degree of circularity of 0.90 or more, wherein the Cl concentration of the ferrite carrier core material measured by an elution method is 0.1 to 100 ppm.

Additionally, the present invention provides the ferrite carrier for an electrophotographic developer, obtained by coating the surface of the ferrite carrier core material with a resin.

Additionally, the present invention provides a method for producing a ferrite carrier core material for an electrophotographic developer, by subjecting to thermal spraying in the air a granulated substance obtained by preparing the raw materials of the ferrite carrier core material together with a binder, and by rapidly cooling and solidifying the resulting thermally sprayed substance, wherein the binder is polyvinyl alcohol having a degree of polymerization of 800 to 3000 and a degree of saponification of 75 to 96 mol % and is contained in an amount of 0.5 to 3.5% by weight in terms of the solid content in relation to the granulated substance.

Additionally, the present invention provides a method for producing a ferrite carrier for an electrophotographic developer, wherein the surface of the ferrite carrier core material obtained by the above-described production method is coated with a resin.

Additionally, the present invention provides an electrophotographic developer including the above-described ferrite carrier or the ferrite carrier obtained by the above-described method and a toner.

The ferrite carrier core material for an electrophotographic developer according to the present invention has an intended high charge amount and is small in the environmental variations of the electric properties including the charge amount. The ferrite carrier for an electrophotographic developer using the ferrite carrier core material can maintain a high chargeability over a long period of time and is small in the environmental variation of the chargeability.

### DETAILED DESCRIPTION OF THE EMBODIMENTS

Hereinafter, the best mode for carrying out the present invention is described.

<Ferrite Carrier Core Material for Electrophotographic Developer and Ferrite Carrier for Electrophotographic Developer according to the Present Invention>

The ferrite carrier core material for an electrophotographic developer according to the present invention has an apparent density of 2.30 to 2.80 g/cm³ and preferably 2.40 to 2.70 g/cm³. In the case where the apparent density of the ferrite carrier core material is less than 2.30 g/cm³, when the resin-coated ferrite carrier is reduced in particle size, the stress at the time of mixing a toner with the ferrite carrier core material is weak and thus the charge rise property is degraded. It is difficult to produce such a ferrite carrier core material as having an apparent density exceeding 2.80 g/cm³.

[Apparent Density]

The measurement of the apparent density is performed according to JIS-Z2504 (Test Method for Apparent Density of Metal Powders).

The ferrite carrier core material for an electrophotographic developer according to the present invention has a BET specific surface area of 0.09 to 0.70 m²/g and preferably 0.10 to 0.60 m²/g. When the BET specific surface area of the ferrite carrier core material is less than 0.09 m²/g, no anchoring effect at the time of resin coating can be expected, and the adhesion between the resin and the ferrite carrier core material is poor. Consequently, when the ferrite carrier core material is used in a developer, the exfoliation of the coating resin occurs due to the stress of mixing with the toner, the exfoliated resin inhibits the charge transferability between the carrier and the toner, and hence the charge rise property is degraded. When the BET specific surface area of the ferrite carrier core material exceeds 0.70 m²/g, the control of the resin coating film thickness is difficult, and hence the core material-exposed portion on the carrier surface comes to be large and it is difficult to obtain an intended high charge amount.

[BET Specific Surface Area]

The BET specific surface area is measured by using a BET specific surface area analyzer (Macsorb HM model 1210) manufactured by Mountech Ltd. A measurement sample is placed in a vacuum dryer, treated at 200° C. for 2 hours, held in the dryer until the temperature comes to be 80° C. or lower, and then taken out from the dryer. Then, the sample is densely packed in the cell and the cell is set in the analyzer. The sample is pretreated at a deaeration temperature of 200° C. for 60 minutes and then the measurement is performed.

The ferrite carrier core material for an electrophotographic developer according to the present invention is required to have a Cl concentration of 0.1 to 100 ppm as measured by an elution method. When chlorides or chloride ions are present in large amounts on the surface of the ferrite carrier core material (ferrite particles), the ferrite carrier core material tends to absorb the moisture (water molecules) in the use environment of the carrier and the developer, and hence the environmental variations of the electric properties including the charge amount come to be large. It is necessary to reduce the chlorides and the chloride ions as much as possible.

However, it is general to use the iron oxide by-produced from the acid cleaning process with hydrochloric acid, occurring in iron steel production, as the iron oxide which is one of the raw materials of the carrier core material (ferrite); thus, chlorides and chloride ions are included as inevitable impurities. The greater part of the chlorides and the chloride ions is removed, when the raw materials are treated at 1000 to 1500° C. in the sintering step using a batch electric furnace or a rotary electric furnace as a ferrite production step; however, it is difficult for heat to penetrate into the interior of the raw materials and hence parts of the chlorides and the chloride ions remain. In particular, when a ferrite particle having a relatively large specific surface area is produced for the purpose of enhancing the chargeability, it is necessary to set the sintering temperature at a relatively lower temperature, and hence the chlorides and the chloride ions tend to remain.

Additionally, when the BET specific surface area is increased for the purpose of enhancing the chargeability, the chlorides and/or the chloride ions remain in larger amounts on the surface of the core material particles as compared to the cases of the ferrites particles used in common resin-coated ferrite carriers, and hence the carrier properties are significantly affected.

Accordingly, in the present invention, as described above, it is necessary to set at 0.1 to 100 ppm the Cl concentration of the ferrite carrier core material, measured by an elution method. The Cl concentration is preferably 0.1 to 70 ppm, more preferably 0.1 to 50 ppm and most preferably 0.1 to 20 ppm. Within this range, the environmental variations of the electric properties including the charge amount are small. Additionally, by applying the below-described oxide film forming treatment, it is possible to make the charge amount high and the environmental variations also remain small.

As described above, when the Cl concentration exceeds 100 ppm, the ferrite carrier core material tends to absorb the moisture (water molecules) in the use environment, and hence unpreferably the environmental variations of the electric properties including the charge amount come to be large. Even when the below-described oxide film forming treatment is applied, it is difficult to attain a high charge amount. Further, also when the surface of the ferrite carrier core material is coated with a resin, the Cl component remaining in the ferrite carrier core material and the coating resin interact with each other, and consequently the decrease of the charge amount tends to occur.

It is industrially difficult to make the Cl concentration less than 0.1 ppm. In general, among the raw materials used for ferrite or the ferrite carrier for an electrophotographic developer, the material which contains particularly Cl in a large amount is iron oxide. This is because as the iron oxide, generally used is the iron oxide by-produced from the acid cleaning process with hydrochloric acid, occurring in iron steel production. Such iron oxide is of several grades, and a few hundred ppm of Cl is contained in any grade. Among the industrially used iron oxides, even the iron oxide smallest in the Cl concentration contains about 200 ppm of Cl.

There are various methods for measuring the Cl concentration. For example, such a method as described in Japanese Patent Laid-Open No. 2006-267345, namely, a method using an X-ray fluorescence element analyzer. However, the Cl concentration measurement method using an X-ray fluorescence element analyzer is a method effective in measuring the Cl present in the interior of the particles, not directly affected by the external environment as well as the Cl present in the vicinity of the surface of the particles. In the present invention, it has been discovered that particularly the occurrence of the interaction of the Cl present in the vicinity of the surface with the moisture in the air adversely affects the environmental variation of the charging property, and it has also been discovered that the factors such as the moisture effect on the chlorides on the surface and the tendency for such chlorides to be exfoliated degrade the chargeability itself; thus, the present invention fundamentally has nothing to do with the Cl present in the interior of the particles. In the present invention, therefore, it is extremely important to specify and control the concentration of the Cl present on the surface of the ferrite particles. As a measurement method suitable for such a purpose, the following elution method is used.

[Cl-Concentration: Elution Method]

(1) A sample is accurately weighed in an amount of 50.000 g to within ±0.0002 g and placed in a 150-ml glass bottle.

(2) To the glass bottle, 50 ml of a phthalic acid salt (pH4.01) is added.

(3) Successively, 1 ml of an ion strength adjuster is added to the glass bottle and the lid of the glass bottle is closed.

(4) The glass bottle is shaken for 10 minutes with a paint shaker.

(5) While a magnet is being brought into contact with the bottom of the 150-ml glass bottle and attention is being paid so as for the carrier not to drop, filtration into a PP vessel (50 ml) is performed with a No. 5B filter paper.

(6) The voltage of the obtained supernatant liquid is measured with a pH meter.

(7) In the same manner, the voltages of the solutions, prepared for obtaining a calibration curve, different in the Cl concentration (pure water, 1 ppm, 10 ppm, 100 ppm and 1000 ppm) are measured, and on the basis of the measured values, the Cl concentration of the sample is calculated.

The average degree of circularity of the ferrite carrier core material for an electrophotographic developer according to the present invention is required to be 0.90 or more. When the average degree of circularity is 0.90 or more, a ferrite carrier extremely excellent in fluidity is obtained. When the average degree of circularity is less than 0.90, the fluidity is unsatisfactory and the charge rise property is degraded.

[Average Degree of Circularity]

For the measurement of the average degree of circularity of the ferrite carrier core material, a particle size/shape distribution analyzer PITA-1 (manufactured by Seishin Enterprise Co., Ltd.) is used. The carrier powder is dispersed in a glycerin solution with a homogenizer and the resulting dispersion is fed to a feed tank. The dispersion is made to flow through the lens particle size detector at a constant flow rate, observed with a CCD camera lens at an observation magnification of 10× and subjected to a measurement of 3000 particles. The degree of circularity is calculated on the basis of the following formula, wherein the area and the circumferential length of the particle required for the calculation of the degree of circularity are automatically calculated from the results of the image analysis.

Degree of circularity=(4π×area)/(circumferential length×circumferential length)

The composition of the ferrite particle used for the ferrite carrier core material for an electrophotographic developer according to the present invention is not particularly limited; however, the concerned composition is preferably represented by the following formula (1) presented as a general formula.

(MnO)ₓ(MgO)_{y}(Fe₂O₃)_{z} (1)

wherein x=35 to 45 mol %, Y=5 to 15 mol % and Z=40 to 60 mol %; X+y+z=100 mol %; part of MnO, MgO and Fe₂O₃ is replaced with SrO in an amount of 0.35 to 5.0 mol %.

The ferrite particle having such a specific composition as described above is high in magnetization and satisfactory in the uniformity of the magnetization (the variation of the magnetization is small), and hence is preferably used.

The carrier core material for an electrophotographic developer according to the present invention is preferably subjected to a surface oxidation treatment so as for an oxide film to be formed thereon. The formation of the oxide film enables the achievement of a high charge amount as well as the regulation of the electric resistance. As the surface oxidation treatment, a heat treatment can be performed, for example, at 300 to 700° C. by using a commonly used electric furnace such as a rotary electric furnace or a batch electric furnace. The thickness of the oxide film is preferably 0.1 nm to 5 μm. When the thickness of the oxide film is less than 0.1 nm, the effect of the oxide film is small, and when the thickness of the oxide film exceeds 5 μm, the magnetization decreases or the resistance comes to be too high, and thus a problem such that the developing power is degraded tends to occur. Additionally, where necessary, reduction may be conducted before the surface oxidation treatment.

The ferrite carrier core material for an electrophotographic developer according to the present invention is preferably such that the volume average particle size is 20 to 100 μm and the magnetization at 3 kOe is 55 to 95 Am²/kg.

Unpreferably, when the volume average particle size of the ferrite carrier core material is less than 20 μm, the carrier scattering tends to occur, and when the volume average particle size exceeds 100 μm, the image quality is degraded.

When the magnetization of the ferrite carrier core material at 3 kOe is less than 55 Am²/kg, the carrier scattering tends to occur, and when the magnetization exceeds 95 Am²/kg, the magnetic brush comes to be too hard and hence such a magnetization offers a cause for image quality degradation.

[Volume Average Particle Size (Microtrac)]

The volume average particle size is measured as follows. Specifically, the volume average particle size is measured with Microtrac Particle Size Analyzer (model 9320-X100) manufactured by Nikkiso Co., Ltd. Water is used as a dispersion medium. In a 100-ml beaker, 10 g of a sample and 80 ml of water are placed, and a few drops of a dispersant (sodium hexametaphosphate) are added in the beaker. Next, the resulting mixture is subjected to dispersion for 20 seconds with an ultrasonic homogenizer (model UH-150, manufactured by SMT Co., Ltd.) set at an output power level of 4. Then, the foam formed on the surface of the resulting dispersed mixture in the beaker is removed and the dispersed mixture is placed as the measurement sample in the measurement apparatus.

[Magnetization]

For the measurement of the magnetization, a vibrating sample magnetometer (model VSM-C7-10A, manufactured by Toei Industry Co., Ltd.) is used. A measurement sample is packed into a cell of 5 mm in inner diameter and 2 mm in height to be set in the above-described apparatus. In the measurement, a magnetic field is applied and the magnetic field is scanned up to a maximum of 3 kOe. Then, the applied magnetic field is decreased, and thus a hysteresis loop is depicted. From the data provided by this loop, the magnetization is derived.

The ferrite carrier for an electrophotographic developer according to the present invention is preferably such that the surface of the ferrite carrier core material is coated with a resin. The carrier properties, in particular, the electric properties including the charge amount are frequently affected by the materials present on the carrier surface and by the properties and conditions of the carrier surface. Accordingly, by coating the surface of the carrier with an appropriate resin, intended carrier properties can be regulated with a satisfactory accuracy.

The coating resin is not particularly limited. Examples of the coating resin include: fluororesins, acrylic resins, epoxy resins, polyamide resins, polyamideimide resins, polyester resins, unsaturated polyester resins, urea resins, melamine resins, alkyd resins, phenolic resins, fluoroacrylic resins, acryl-styrene resins and silicone resins; and modified silicone resins obtained by modification with a resin such as an acrylic resin, a polyester resin, an epoxy resin, a polyamide resin, a polyamideimide resin, an alkyd resin, a urethane resin or a fluororesin. In consideration of the detachment of the resin due to the mechanical stress during use, thermosetting resins are preferably used. Specific examples of the thermosetting resins include epoxy resins, phenolic resins, silicone resins, unsaturated polyester resins, urea resins, melamine resins, alkyd resins and resins containing these resins. The coating amount of the resin is preferably 0.5 to 5.0 parts by weight in relation to 100 parts by weight of the ferrite carrier core material (before resin coating).

The coating resin can also contain a charge control agent. Examples of the charge control agent include various charge control agents commonly used for toners and various silane coupling agents. This is because the charge imparting capability is degraded as the case may be when a large amount of a resin is coated, but the charge imparting capability can be controlled by adding various charge control agents or various silane coupling agents. The usable types of the charge control agents and the silane coupling agents are not particularly limited; preferable examples of the usable charge control agents and silane coupling agents include: charge control agents such as nigrosine dyes, quaternary ammonium salts, organometallic complexes and metal-containing monoazo dyes; and aminosilane coupling agents and fluorosilane coupling agents.

Further, for the purpose of controlling the electric resistance, the charge amount and the charging rate of the carrier, a conductive agent can be added in the coating resin, in addition to the above-described charge control agent. The electric resistance of the conductive agent itself is low, and hence when the addition amount of the conductive agent is too large, a rapid charge leakage tends to occur. Accordingly, the addition amount of the conductive agent is 0.25 to 20.0% by weight, preferably 0.5 to 15.0% by weight and particularly preferably 1.0 to 10.0% by weight in relation to the solid content of the coating resin. Examples of the conductive agent include conductive carbon, oxides such as tin oxide and titanium oxide, and various organic conductive agents.

<Methods for Producing Ferrite Carrier Core Material for Electrophotographic Developer and Ferrite Carrier for Electrophotographic Developer according to the Present Invention>

The methods for producing the ferrite carrier core material for an electrophotographic developer and the ferrite carrier for an electrophotographic developer according to the present invention are described.

The method for producing the ferrite carrier core material for an electrophotographic developer according to the present invention is a method in which a granulated substance obtained by preparing the raw materials of the ferrite carrier core material together with a binder is thermally sprayed in the air and then rapidly cooled and solidified.

The method for obtaining the granulated substance by preparing the raw materials of the ferrite carrier core material together with a binder is not particularly limited; heretofore known methods can be adopted as such a method, and such a method may be either a dry method or a wet method.

Examples of the granulation method include a method in which the raw materials of the ferrite carrier core material are weighed out in appropriate amounts and mixed together; then water and a binder are added to the resulting mixture and then the resulting mixture is pulverized to prepare a slurry; the obtained slurry is granulated by a spray dryer; the resulting particles are classified to prepare a granulated substance having a predetermined particle size. The particle size of the granulated substance is preferably about 20 to 100 μm in consideration of the particle size of the ferrite carrier core material to be obtained. Examples of the granulation method also include another method in which the raw materials of the ferrite carrier core material and a binder are weighed out, then mixed together and dry pulverized; thus the individual raw materials and the like are pulverized and dispersed; the resulting mixture is granulated with a granulator and the resulting particles are classified to prepare a granulated substance having a predetermined particle size.

In the production method according to the present invention, polyvinyl alcohol (PVA) having a degree of polymerization of 800 to 3000 and a degree of saponification of 75 to 96 mol % is used as a binder. The reasons for using such a binder are as follows.

Specifically, in contrast to the sintering temperature of 1000 to 1500° C. in the conventional ferritization using an electric furnace or the like, the sintering temperature based on the thermal spraying reaches 2000 to 3500° C. When the properties of polyvinyl alcohol falls within the above-described ranges, the chlorides or the chloride ions tend to be vaporized/gasified in the sintering based on thermal spraying, and consequently the Cl amount in the obtained ferrite carrier core material is reduced. In the temperature range of the conventional sintering using an electric furnace or the like, the chlorides or the chloride ions cannot be sufficiently removed, additionally the variation of the Cl amount is large, and hence the production stability suffers from troubles.

When the degree of polymerization of polyvinyl alcohol as a binder is less than 800, the strength of the granulated substance is brittle, the particle fracture occurs during the thermal spraying treatment, and hence the intended particle size or the intended particle shape is not obtained. At the time of thermal spraying sintering, the decomposition of polyvinyl alcohol is too fast (the —C—C— bond is easily broken), and hence the chlorides or the chloride ions in the granulated substance neither can be vaporized/gasified as the decomposed products accompanying the decomposition of polyvinyl alcohol nor can be oxidized, and consequently the chlorides or the chloride ions remain. When the degree of polymerization of polyvinyl alcohol exceeds 3000, the water solubility is decreased and the viscosity is increased at the time of the preparation of the slurry, and hence the granulated substance comes to be a substance composed of large agglomerates and accordingly it is difficult to prepare the raw material. At the time of thermal spraying sintering, it is difficult to decompose polyvinyl alcohol (it is difficult to break the —C—C— bond), the chlorides or the chloride ions in the granulated substance are not vaporized/gasified as the decomposed products accompanying the decomposition of polyvinyl alcohol, and hence polyvinyl alcohol and the chlorides or the chloride ions all remain together.

When the degree of saponification of polyvinyl alcohol as a binder is less than 75 mol %, the water solubility at the time of the slurry preparation is insufficient, the unevenness of the amount of polyvinyl alcohol included in the granulated substance from one particle to another comes to be large. Consequently, depending on the particle, the amount of the chlorides or the chloride ions in the granulated substance cannot be such an appropriate value that allows the chlorides or the chloride ions to be vaporized/gasified as the decomposed products accompanying the decomposition of polyvinyl alcohol, and hence the chlorides or the chloride ions remain. Because when the degree of saponification of polyvinyl alcohol exceeds 96 mol %, the crystallinity of polyvinyl alcohol is high and hence the shape of the granulated substance comes to be distorted due to the drying/cooling after the spray drying, the intended particle size or the intended shape is not obtained. The structure of polyvinyl alcohol is hardly distorted and hence the presence of polyvinyl alcohol in the granulated substance is localized, and hence the chlorides or the chloride ions cannot be vaporized/gasified as the decomposed products accompanying the decomposition of polyvinyl alcohol or cannot be oxidized, and consequently the chlorides or the chloride ions remain.

The content of polyvinyl alcohol as a binder in the granulated substance is 0.5 to 3.5% by weight in terms of the solid content. By using such an amount of polyvinyl alcohol, the intended ferrite carrier core material is obtained. When the content of polyvinyl alcohol is less than 0.5% by weight in terms of the solid content, such a content is insufficient to meet the absolutely necessary amount for vaporizing/gasifying the chlorides or the chloride ions as the accompanying decomposed product or for oxidizing the chlorides or the chloride ions, and hence the chlorides or the chloride ions remain. Additionally, the adhesion strength of the granulated substance is brittle, and hence particle fracture occurs during the thermal spraying treatment and the intended particle size is not obtained. When the content of polyvinyl alcohol exceeds 3.5% by weight in terms of the solid content, the bumping of polyvinyl alcohol occurs at the time of thermal spraying sintering. The bumped fraction of polyvinyl alcohol is not decomposed and is instantly discharged as a gas to outside the granulated substance system, and hence cannot vaporize/gasify the chlorides or the chloride ions in the granulated substance as the accompanying decomposed products. Additionally, the fraction of polyvinyl alcohol not involved in bumping remains in the sintered substance without being gasified or decomposed. Further, the gas bumped at the time of thermal spraying produces hollow portions, and hence no intended particle density is obtained. In some cases, the gas that forms the hollow portions is excessive and the hollow portions are too large, and consequently the particles are fractured and even neither the intended particle size nor the intended shape is obtained.

The granulated substance prepared as described above is thermally sprayed in the air. For thermal spraying, a combustion gas and oxygen are used as the combustion flame of a combustible gas, and the volume ratio between the combustion gas and oxygen is 1:3.5 to 6.0. When the ratio of oxygen to the combustion gas is less than 3.5, the melting is not sufficient and when the ratio of oxygen to the combustion gas exceeds 6.0, ferritization comes to be difficult. For example, oxygen gas is used in an amount of 35 to 65 Nm³/hr in relation to 10 Nm³/hr of the combustion gas.

Examples of the combustion gas used in the thermal spraying include propane gas, propylene gas and acetylene gas; in particular, propane gas is preferably used. The flow velocity of the granulated substance is preferably 20 to 60 m/sec. In this case, the flame temperature of the burner used in the thermal spraying is preferably set at 2000 to 3500° C. and the flame transit time is preferably set at 10 seconds or less.

The particles thus obtained by thermal spraying are placed in the air or in water to be rapidly cooled and solidified. Then, the solidified particles are collected, dried and classified to yield the ferrite carrier core material. As the classification method, the existing methods such as a pneumatic classification method, a mesh filtration method and a precipitation method are used to regulate the particle size to an intended particle size.

In the production method according to the present invention, a resin-coated ferrite carrier is obtained by coating with a resin the surface of the above-described ferrite carrier core material. The carrier properties, in particular, the electric properties including the charge amount are frequently affected by the materials present on the carrier surface and by the properties and conditions of the carrier surface. Accordingly, by coating the surface of the carrier with an appropriate resin, intended carrier properties can be regulated with a satisfactory accuracy. As the method for coating, heretofore known methods such as a brush coating method, a dry method, a spray drying method based on a fluidized bed, a rotary drying method and a dip-and-dry method using a universal stirrer can be applied for coating. For the purpose of improving the coverage factor, a method based on the fluidized bed is preferable. When baking is performed after the resin coating, either an external heating method or an internal heating method may be used; for example, a fixed electric furnace, a fluid-type electric furnace, a rotary electric furnace or a burner furnace may be used, or baking with microwave may also be adopted. When a UV curable resin is used, a UV heater is used. The baking temperature is varied depending on the resin used; the baking temperature is required to be a temperature equal to or higher than the melting point or the glass transition point; when a thermosetting resin, a condensation-crosslinking resin or the like is used, the baking temperature is required to be increased to a temperature allowing the curing to proceed sufficiently.

<Electrophotographic Developer according to the Present Invention>

Next, the electrophotographic developer according to the present invention is described.

The electrophotographic developer according to the present invention is composed of the above-described carrier for an electrophotographic developer and a toner.

Examples of the toner particle that constitutes the electrophotographic developer of the present invention include a pulverized toner particle produced by a pulverization method and a polymerized toner particle produced by a polymerization method. In the present invention, the toner particle obtained by either of these methods can be used.

The pulverized toner particle can be obtained, for example, by means of a method in which a binder resin, a charge control agent and a colorant are fully mixed with a mixing machine such as a Henschel mixer, then the resulting mixture is melt-kneaded with an apparatus such as a double screw extruder, and the melt-kneaded mixture is cooled, then pulverized and classified; an external additive is added to the resulting classified particle, and then the resulting mixture is mixed with a mixing machine such as a mixer to yield the pulverized toner particle.

The binder resin that constitutes the pulverized toner particle is not particularly limited. However, examples of the binder resin may include polystyrene, chloropolystyrene, styrene-chlorostyrene copolymer, styrene-acrylate copolymer and styrene-methacrylic acid copolymer, and further, rosin-modified maleic acid resin, epoxy resin, polyester resin and polyurethane resin. These binder resins are used each alone or as mixtures thereof.

As the charge control agent, any charge control agent can be used. Examples of the charge control agent for use in positively charged toners may include nigrosine dyes and quaternary ammonium salts. Additionally, examples of the charge control agent for use in negatively charged toners may include metal-containing monoazo dyes.

As the colorant (coloring material), hitherto known dyes and pigments can be used. Examples of the usable colorant include carbon black, phthalocyanine blue, permanent red, chrome yellow and phthalocyanine green. Additionally, for the purpose of improving the fluidity and the anti-aggregation property of the toner, external additives such as a silica powder and titania can be added to the toner particle according to the toner particle.

The polymerized toner particle is a toner particle produced by heretofore known methods such as a suspension polymerization method, an emulsion polymerization method, an emulsion aggregation method, an ester extension polymerization method and a phase inversion emulsification method. Such a polymerized toner particle can be obtained, for example, as follows: a colorant dispersion liquid in which a colorant is dispersed with a surfactant in water, a polymerizable monomer, a surfactant and a polymerization initiator are mixed in a aqueous medium under stirring to disperse the polymerizable monomer by emulsification in the aqueous medium; the polymerizable monomer thus dispersed is polymerized under stirring for mixing; then, the polymer particles are salted out by adding a salting-out agent; the particles obtained by salting-out are filtered off, rinsed and dried, and thus the polymerized toner particle can be obtained. Then, where necessary, an external additive is added to the dried toner particle.

Further, when the polymerized toner particle is produced, in addition to the polymerizable monomer, the surfactant, the polymerization initiator and the colorant, a fixability improving agent and a charge controlling agent can also be mixed; the various properties of the obtained polymerized toner particle can be controlled and improved by these agents. Additionally, a chain transfer agent can also be used for the purpose of improving the dispersibility of the polymerizable monomer in the aqueous medium and regulating the molecular weight of the obtained polymer.

The polymerizable monomer used in the production of the polymerized toner particle is not particularly limited; however, example of such a polymerizable monomer may include: styrene and the derivatives thereof; ethylenically unsaturated monoolefins such as ethylene and propylene; vinyl halides such as vinyl chloride; vinyl esters such as vinyl acetate; and α-methylene aliphatic monocarboxylic acid esters such as methyl acrylate, ethyl acrylate, methyl methacrylate, ethyl methacrylate, 2-ethylhexyl methacrylate, acrylic acid dimethylamino ester and methacrylic acid diethylamino ester.

As the colorant (coloring material) used when the polymerized toner particle is prepared, hitherto known dyes and pigments can be used. Examples of the usable colorant include carbon black, phthalocyanine blue, permanent red, chrome yellow and phthalocyanine green. Additionally, the surface of each of these colorants may be modified by using a silane coupling agent, a titanium coupling agent or the like.

As the surfactant used in the production of the polymerized toner particle, anionic surfactants, cationic surfactants, amphoteric surfactants and nonionic surfactants can be used.

Here, examples of the anionic surfactants may include: fatty acid salts such as sodium oleate and castor oil; alkyl sulfates such as sodium lauryl sulfate and ammonium lauryl sulfate; alkylbenzenesulfonates such as sodium dodecylbenzenesulfonate; alkylnaphthalenesulfonates; alkylphosphoric acid ester salts; naphthalenesulfonic acid-formalin condensate; and polyoxyethylene alkyl sulfuric acid ester salts. Additionally, examples of the nonionic surfactants may include: polyoxyethylene alkyl ethers, polyoxyethylene fatty acid esters, sorbitan fatty acid esters, polyoxyethylene alkylamines, glycerin, fatty acid esters and oxyethylene-oxypropylene block polymer. Further, examples of the cationic surfactants may include: alkylamine salts such as laurylamine acetate; and quaternary ammonium salts such as lauryltrimethylammonium chloride and stearyltrimethylammonium chloride. Additionally, examples of the amphoteric surfactants may include aminocarboxylic acid salts and alkylamino acids.

The above-described surfactants can each be used usually in a range from 0.01 to 10% by weight in relation to the polymerizable monomer. The used amount of such a surfactant affects the dispersion stability of the monomer, and also affects the environment dependence of the obtained polymerized toner particle, and hence such a surfactant is preferably used within the above-described range in which the dispersion stability of the monomer is ensured and the environment dependence of the polymerized toner particle is hardly excessively affected.

For the production of the polymerized toner particle, usually a polymerization initiator is used. Examples of the polymerization initiator include water-soluble polymerization initiators and oil-soluble polymerization initiators. In the present invention, either of a water-soluble polymerization initiator and an oil-soluble polymerization initiator can be used. Examples of the water-soluble polymerization initiator usable in the present invention may include: persulfates such as potassium persulfate and ammonium persulfate; and water-soluble peroxide compounds. Additionally, examples of the oil-soluble polymerization initiator usable in the present invention may include: azo compounds such as azobisisobutyronitrile; and oil-soluble peroxide compounds.

Additionally, for a case where a chain transfer agent is used in the present invention, examples of the chain transfer agent may include: mercaptans such as octylmercaptan, dodecylmercaptan and tert-dodecylmercaptan; and carbon tetrabromide.

Further, for a case where the polymerized toner particle used in the present invention contains a fixability improving agent, examples of the usable fixability improving agent include: natural waxes such as carnauba wax; and olefin waxes such as polypropylene wax and polyethylene wax.

Additionally, for a case where the polymerized toner particle used in the present invention contains a charge control agent, the charge control agent used is not particularly limited, and examples of the usable charge controlling agent include nigrosine dyes, quaternary ammonium salts, organometallic complexes and metal-containing monoazo dyes.

Additionally, examples of the external additives used for improving the fluidity and the like of the polymerized toner particle may include silica, titanium oxide, barium titanate, fluororesin fine particles and acrylic resin fine particles. These external additives can be used each alone or in combinations thereof.

Further, examples of the salting-out agent used for separation of the polymerized particles from the aqueous medium may include metal salts such as magnesium sulfate, aluminum sulfate, barium chloride, magnesium chloride, calcium chloride and sodium chloride.

The average particle size of the toner particle produced as described above falls in a range from 2 to 15 μm and preferably in a range from 3 to 10 μm, and the polymerized toner particle is higher in the particle uniformity than the pulverized toner particle. When the average particle size of the toner particle is less than 2 μm, the chargeability is degraded to tend to cause fogging or toner scattering; when larger than 15 μm, such a particle size offers a cause for image quality degradation.

Mixing of the carrier and the toner produced as described above can yield an electrophotographic developer. The mixing ratio between the carrier and the toner, namely, the toner concentration is preferably set at 3 to 15% by weight. When the toner concentration is less than 3% by weight, it is difficult to attain an intended image density; when larger than 15% by weight, toner scattering or fogging tends to occur.

The developer obtained by mixing the carrier and the toner produced as described above can be used as a refill developer. In this case, the mixing is performed with the mixing ratio between the carrier and the toner such that 1 part by weight of the carrier is mixed with 2 to 50 parts by weight of the toner.

The electrophotographic developer according to the present invention, prepared as described above, can be used in a digital image formation apparatus, such as a copying machine, a printer, a FAX machine or a printing machine, adopting a development method in which an electrostatic latent image formed on a latent image holder having an organic photoconductor layer is reversely developed, while applying a bias electric field, with a magnetic brush of a two-component developer having a toner and a carrier. Additionally, the electrophotographic developer according to the present invention is also applicable to an image formation apparatus, such as a full-color machine, which adopts a method applying an alternating electric field composed of a DC bias and an AC bias superposed on the DC bias when a development bias is applied from the magnetic brush to the electrostatic latent image.

Hereinafter, the present invention is specifically described on the basis of Examples and others.

### Example 1

The raw materials of the ferrite carrier were weighed out so as to give a composition composed of MnO: 39.6 mol %, MgO: 9.6 mol %, Fe₂O₃: 50 mol % and SrO: 0.8 mol %; water and polyvinyl alcohol as a binder were added to the weighed raw materials and the resulting mixture was pulverized for 2 hours with a bead mill; then from the pulverized mixture, a granulated substance was prepared with a spray dryer so as for the volume average particle size after sintering to be 33 to 37 μm. The degree of polymerization and the degree of saponification of the polyvinyl alcohol used herein were 2000 and 88 mol %, respectively; the binder content in terms of the solid content and the carbon content in the granulated substance were 1.2% by weight and 1.33% by weight, respectively.

The obtained granulated substance was made to pass under the condition of the feed rate of 60 kg/hr through a flame to which 8 Nm³/hr of propane and 32 Nm³/hr of oxygen were fed, and thus a finally sintered substance was obtained. The feeding of the granulated substance to the flame was performed with pneumatic transport using oxygen gas and the feed rate of the oxygen gas was set at 10 Nm³/hr. The obtained sintered substance was classified, magnetically separated and thus a ferrite carrier core material composed of ferrite particles was obtained. The carbon content in the obtained ferrite carrier core material was less than 0.01% by weight.

### Example 2

Ferrite particles (a ferrite carrier core material) were obtained in the same manner as in Example 1 except that the feed rate of propane and the feed rate of oxygen at the time of thermal spraying were set at 5.5 Nm³/hr and 22 Nm³/hr, respectively.

### Example 3

Ferrite particles (a ferrite carrier core material) were obtained in the same manner as in Example 1 except that the feed rate of propane and the feed rate of oxygen at the time of thermal spraying were set at 11 Nm³/hr and 44 Nm³/hr, respectively.

### Example 4

Ferrite particles (a ferrite carrier core material) were obtained in the same manner as in Example 1 except that polyvinyl alcohol having a degree of polymerization of 1000 and a degree of saponification of 89 mol % was used as a binder.

### Example 5

Ferrite particles (a ferrite carrier core material) were obtained in the same manner as in Example 1 except that polyvinyl alcohol having a degree of polymerization of 2400 and a degree of saponification of 87 mol % was used as a binder.

### Example 6

Ferrite particles (a ferrite carrier core material) were obtained in the same manner as in Example 1 except that polyvinyl alcohol having a degree of polymerization of 2000 and a degree of saponification of 79 mol % was used as a binder.

### Example 7

Ferrite particles (a ferrite carrier core material) were obtained in the same manner as in Example 1 except that polyvinyl alcohol having a degree of polymerization of 2400 and a degree of saponification of 95 mol % was used as a binder.

### Example 8

Ferrite particles (a ferrite carrier core material) were obtained in the same manner as in Example 1 except that the binder content in terms of the solid content in the granulated substance was set at 0.8% by weight.

### Example 9

Ferrite particles (a ferrite carrier core material) were obtained in the same manner as in Example 1 except that the binder content in terms of the solid content in the granulated substance was set at 3.0% by weight.

### Comparative Example 1

A granulated substance was obtained by using the same raw materials of the ferrite carrier core material and the same binder as in Example 1 and in the same manner as in Example 1.

Next, the obtained granulated substance was sintered in a tunnel electric furnace at a sintering temperature of 1250° C. and with an oxygen concentration of 3.0 vol %. The obtained sintered substance was classified, magnetically separated and thus a ferrite carrier core material composed of ferrite particles was obtained.

### Comparative Example 2

Ferrite particles (a ferrite carrier core material) were obtained in the same manner as in Comparative Example 1 except that the sintering was performed at a sintering temperature of 1100° C. and with an oxygen concentration of 0 vol %.

### Comparative Example 3

Ferrite particles (a ferrite carrier core material) were obtained in the same manner as in Example 1 except that polyvinyl alcohol having a degree of polymerization of 600 and a degree of saponification of 87 mol % was used as a binder.

### Comparative Example 4

Ferrite particles (a ferrite carrier core material) were obtained in the same manner as in Example 1 except that polyvinyl alcohol having a degree of polymerization of 3500 and a degree of saponification of 85 mol % was used as a binder.

### Comparative Example 5

Ferrite particles (a ferrite carrier core material) were obtained in the same manner as in Example 1 except that polyvinyl alcohol having a degree of polymerization of 2000 and a degree of saponification of 72 mol % was used as a binder.

### Comparative Example 6

Ferrite particles (a ferrite carrier core material) were obtained in the same manner as in Example 1 except that polyvinyl alcohol having a degree of polymerization of 2400 and a degree of saponification of 98 mol % was used as a binder.

### Comparative Example 7

Ferrite particles (a ferrite carrier core material) were obtained in the same manner as in Example 1 except that the binder content in terms of the solid content in the granulated substance was set at 0.1% by weight.

### Comparative Example 8

Ferrite particles (a ferrite carrier core material) were obtained in the same manner as in Example 1 except that the binder content in terms of the solid content in the granulated substance was set at 5% by weight.

For each of Examples 1 to 9 and Comparative Examples 1 to 8, the properties (degree of polymerization and degree of saponification) of the used PVA, the PVA content in the granulated substance, the carbon content in the granulated substance, the sintering method, the thermal spraying conditions (propane feed rate, oxygen feed rate, oxygen feed rate for powder feeding and powder feed rate), the electric furnace sintering conditions and the carbon content after sintering are shown in Table 1; and additionally, the Cl concentration (elution method), the BET specific surface area, the apparent density, the average degree of circularity, the volume average particle size, the magnetization (3 kOe), the charge amounts (LL environment, NN environment, HH environment) of the ferrite carrier core material, the charge amount ratio between different environments (LL/HH) and the evaluation result are shown in Tables 2 and 3. Here, the LL, NN and HH environments mean a low-temperature low-humidity (temperature: 10 to 15° C., relative humidity: 20 to 25%) environment, a normal-temperature normal-humidity (temperature: 20 to 25° C., relative humidity: 50 to 60%) environment and a high-temperature high-humidity (temperature: 30 to 35° C., relative humidity: 80 to 85%) environment, respectively.

The measurement method of the charge amount is as follows, and the measurement methods of the other properties are as described above.

[Charge Amount]

A ferrite carrier (a core material) and a commercially available negatively polar toner (cyan toner for use in DocuPrintC3530, manufactured by Fuji Xerox Co., Ltd.) for use in full-color printers were weighed out so as to give a toner concentration of 6.5% by weight (the weight of the toner=3.25 g, the weight of the carrier=46.75 g). The weighed carrier and toner were exposed to the respective environments (LL environment, NN environment and HH environment) for 12 hours or more. Then, the carrier and the toner were placed in a 50-cc glass bottle and stirred for 30 minutes at a rotation number of 100 rpm.

As a charge amount measurement apparatus, a magnet roll consisting of a magnet (magnetic flux density: 0.1 T) having eight poles in total with the N poles and the S poles alternately disposed was disposed inside a cylindrical aluminum element tube (hereinafter, referred to as a sleeve) of 31 mm in diameter and 76 mm in length, and a cylindrical electrode was disposed around the outer circumference of the sleeve with a gap of 5.0 mm.

On the sleeve, 0.5 g of the developer was uniformly adhered, and then while the sleeve was being fixed and the magnet roll inside the sleeve was being rotated at 100 rpm, a direct current voltage of 2000 V was applied for 60 seconds between the electrode and the sleeve, and thus the toner was transferred to the electrode. In this case, an electrometer (Insulation resistance meter, model 6517A, manufactured by Keithley Instruments Inc.) was connected to the cylindrical electrode, and the electric charge quantity of the transferred toner was measured.

After an elapsed time of 60 seconds, the applied voltage was turned off and the rotation of the magnet roll was stopped, and then the electrode was separated and the weight of the toner transferred to the electrode was measured.

The charge amount was calculated from the measured electric charge quantity and the measured weight of the transferred toner.

The evaluation was performed with respect to the charge amount ratio (environmental variation) on the basis of the following four grades: A: excellent, B: good, C: average, D: poor.

TABLE 1

| | Properties of PVA | | PVA | Carbon | | Thermal spraying condition | | | | | Carbon |
|---|---|---|---|---|---|---|---|---|---|---|---|
| | | Degree of | content in | content in | | | | Oxygen feed | | Electric | content |
| | Degree of | saponifi- | granulated | granulated | | Propane | Oxygen | rate for powder | Powder | furnance | after |
| | polymer- | cation | substance | substance | Sintering | feed rate | feed rate | feeding | feed rate | sintering | sintering |
| | ization | (mol%) | (wt%) | (wt%) | method | (Nm³/hr) | (Nm³/hr) | (Nm³/hr) | (kg/hr) | condition | (wt%) |
| Example 1 | 2000 | 88 | 1.2 | 1.33 | Thermal | 8 | 32 | 10 | 60 | — | <0.01 |
| Example 2 | 2000 | 88 | 1.2 | 1.27 | spraying | 5.5 | 22 | 10 | 60 | — | <0.01 |
| Example 3 | 2000 | 88 | 1.2 | 1.35 | | 11 | 44 | 10 | 60 | — | <0.01 |
| Example 4 | 1000 | 89 | 1.2 | 1.28 | | 8 | 32 | 10 | 60 | — | <0.01 |
| Example 5 | 2400 | 87 | 1.2 | 1.29 | | 8 | 32 | 10 | 60 | — | 0.01 |
| Example 6 | 2000 | 79 | 1.2 | 1.31 | | 8 | 32 | 10 | 60 | — | <0.01 |
| Example 7 | 2400 | 95 | 1.2 | 1.29 | | 8 | 32 | 10 | 60 | — | 0.01 |
| Example 8 | 2000 | 88 | 0.8 | 0.89 | | 8 | 32 | 10 | 60 | — | <0.01 |
| Example 9 | 2000 | 88 | 3.0 | 3.33 | | 8 | 32 | 10 | 60 | — | 0.01 |
| Comparative | 2000 | 88 | 1.2 | 1.30 | Electric | — | — | — | — | 1250° C., | 0.02 |
| Example 1 | | | | | furnance | | | | | O₂: 3.0% | |
| Comparative | 2000 | 88 | 1.2 | 1.30 | | — | — | — | — | 1100° C., | 0.03 |
| Example 2 | | | | | | | | | | O₂: 0% | |
| Comparative | 600 | 87 | 1.2 | 1.28 | Thermal | 8 | 32 | 10 | 60 | — | <0.01 |
| Example 3 | | | | | spraying | | | | | | |
| Comparative | 3500 | 85 | 1.2 | 1.29 | | 8 | 32 | 10 | 60 | — | 0.04 |
| Example 4 | | | | | | | | | | | |
| Comparative | 2000 | 72 | 1.2 | 1.31 | | 8 | 32 | 10 | 60 | — | <0.01 |
| Example 5 | | | | | | | | | | | |
| Comparative | 2400 | 98 | 1.2 | 1.21 | | 8 | 32 | 10 | 60 | — | 0.01 |
| Example 6 | | | | | | | | | | | |
| Comparative | 2000 | 88 | 0.1 | 0.11 | | 8 | 32 | 10 | 60 | — | <0.01 |
| Example 7 | | | | | | | | | | | |
| Comparative | 2000 | 88 | 5 | 5.54 | | 8 | 32 | 10 | 60 | — | 0.06 |
| Example 8 | | | | | | | | | | | |

TABLE 2

| | Properties of ferrite carrier core material | | | | | |
|---|---|---|---|---|---|---|
| | Cl | BET | | | Volume | |
| | concentration | specific | Apparent | Average | average | Magnetization |
| | (elution | surface | density | degree of | particle | 3000 Oe |
| | method) (ppm) | area (m²/g) | (g/m³) | circularity | size (μm) | (Am²/kg) |
| Example 1 | 3.5 | 0.2192 | 2.57 | 0.94 | 34.8 | 72 |
| Example 2 | 4.2 | 0.0921 | 2.48 | 0.91 | 36.8 | 70 |
| Example 3 | 3.5 | 0.5684 | 2.60 | 0.95 | 33.2 | 73 |
| Example 4 | 10.1 | 0.1134 | 2.56 | 0.91 | 33.1 | 71 |
| Example 5 | 13.1 | 0.3892 | 2.52 | 0.94 | 36.8 | 71 |
| Example 6 | 26.8 | 0.1725 | 2.56 | 0.95 | 33.8 | 70 |
| Example 7 | 27.9 | 0.3762 | 2.54 | 0.91 | 36.7 | 70 |
| Example 8 | 65.1 | 0.2899 | 2.57 | 0.94 | 33.1 | 73 |
| Example 9 | 86.2 | 0.1078 | 2.32 | 0.95 | 36.9 | 71 |
| Comparative | 134.2 | 0.0842 | 2.32 | 0.90 | 34.2 | 68 |
| Example 1 | | | | | | |
| Comparative | 137.2 | 0.6324 | 1.92 | 0.90 | 35.6 | 71 |
| Example 2 | | | | | | |
| Comparative | 102.3 | 0.0987 | 2.53 | 0.88 | 30.2 | 69 |
| Example 3 | | | | | | |
| Comparative | 131.5 | 0.4027 | 2.43 | 0.91 | 40.2 | 71 |
| Example 4 | | | | | | |
| Comparative | 132.5 | 0.1593 | 2.58 | 0.93 | 34.7 | 71 |
| Example 5 | | | | | | |
| Comparative | 121.3 | 0.4340 | 2.56 | 0.88 | 38.8 | 73 |
| Example 6 | | | | | | |
| Comparative | 189.3 | 1.172 | 2.30 | 0.92 | 27.2 | 70 |
| Example 7 | | | | | | |
| Comparative | 168.2 | 0.5872 | 1.91 | 0.72 | 43.5 | 73 |
| Example 8 | | | | | | |

TABLE 3

| | Properties of ferrite carrier core material | | | | |
|---|---|---|---|---|---|
| | | | | Charge | Evaluation |
| | | | | amount ratio | Charge amount |
| | Charge amount | | | between | ratio |
| | (μC/g) | | | different | (environmental |
| | HH | NN | LL | environments | variation) |
| | environment | environment | environment | LL/HH | LL/HH |
| Example 1 | 15.0 | 15.2 | 15.4 | 1.0 | A |
| Example 2 | 7.9 | 8.2 | 8.3 | 1.1 | A |
| Example 3 | 53.7 | 54.2 | 54.7 | 1.0 | A |
| Example 4 | 7.2 | 7.5 | 7.7 | 1.1 | A |
| Example 5 | 34.7 | 36.1 | 38.3 | 1.1 | A |
| Example 6 | 10.6 | 12.0 | 13.7 | 1.3 | B |
| Example 7 | 31.9 | 36.2 | 42.7 | 1.3 | B |
| Example 8 | 17.8 | 21.7 | 26.9 | 1.5 | C |
| Example 9 | 8.3 | 10.2 | 12.2 | 1.5 | C |
| Comparative | 19.9 | 32.1 | 44.3 | 2.2 | D |
| Example 1 | | | | | |
| Comparative | 25.3 | 63.2 | 69.5 | 2.8 | D |
| Example 2 | | | | | |
| Comparative | 3.7 | 5.2 | 6.5 | 1.7 | D |
| Example 3 | | | | | |
| Comparative | 15.6 | 28.4 | 38.6 | 2.5 | D |
| Example 4 | | | | | |
| Comparative | 7.4 | 9.2 | 18.0 | 2.4 | D |
| Example 5 | | | | | |
| Comparative | 18.7 | 28.8 | 38.0 | 2.0 | D |
| Example 6 | | | | | |
| Comparative | 1.2 | 2.3 | 4.6 | 4.0 | D |
| Example 7 | | | | | |
| Comparative | 2.2 | 3.6 | 7.9 | 3.7 | D |
| Example 8 | | | | | |

As is evident from the results shown in Tables 2 and 3, in each of Examples 1 to 9, the chlorine concentration of the ferrite carrier core material is as low as 100 ppm or less, a stable charge amount is obtained, and the environmental variation of the charge amount is small. On the contrary, in each of Comparative Examples 1 to 8, the chlorine concentration of the ferrite carrier core material exceeds 100 ppm and the environmental variation of the charge amount is large.

### Example 10

The ferrite carrier core material obtained in Example 1 was subjected to a surface oxidation treatment in a rotary electric furnace under the conditions of the surface oxidation treatment temperature set at 680° C. and the air atmosphere, and thus a 1-μm thick oxide film was formed.

### Comparative Example 9

The ferrite carrier core material obtained in Comparative Example 1 was subjected to a surface oxidation treatment in a rotary electric furnace under the conditions of the surface oxidation treatment temperature set at 680° C. and the air atmosphere, and thus a 1-μm thick oxide film was formed.

For each of the ferrite carrier core materials obtained in Example 10 and Comparative Example 9, on the surface of each of which an oxide film was formed, the Cl concentration (elution method), the BET specific surface area, the apparent density, the average degree of circularity, the volume average particle size, the magnetization (3 kOe), the charge amounts (LL environment, NN environment and HH environment), the charge amount ration between before and after the oxide film forming treatment, the charge amount ratio (LL/HH) between different environments and the evaluation are shown in Tables 4 and 5. The measurement methods and the evaluation methods of these quantities are the same as described above.

TABLE 4

| | | Properties of ferrite carrier core material after surface oxidation treatment | | | | | |
|---|---|---|---|---|---|---|---|
| | | Cl | BET | | | Volume | |
| | Ferrite | concentration | specific | Apparent | Average | average | Magnetization |
| | carrier core | (elution | surface | density | degree of | particle | 3000 Oe |
| | material | method) (ppm) | area (m²/g) | (g/m³) | circularity | size (μm) | (Am²/kg) |
| Example 10 | Example 1 | 3.2 | 0.2092 | 2.54 | 0.93 | 34.2 | 58 |
| Comparative | Comparative | 126.3 | 0.0867 | 2.34 | 0.91 | 34.0 | 64 |
| Example 9 | Example 1 | | | | | | |

TABLE 5

| | | Properties of ferrite carrier core material after surface oxidation treatment | | | | | |
|---|---|---|---|---|---|---|---|
| | | | | | Charge amount | | |
| | | | | | ratio between | Charge | Evaluation |
| | | | | | before and after | amount ratio | Charge |
| | | | | | surface oxidation | between | amount ratio |
| | Ferrite | Charge amount (μC/g) | | | treatment | different | (environmental |
| | carrier core | HH | NN | LL | After treatment/ | environments | variation) |
| | material | environment | environment | environment | before treatment | LL/HH | LL/HH |
| Example 10 | Example 1 | 32.5 | 33.2 | 33.6 | 2.2 | 1.0 | A |
| Comparative | Comparative | 18.8 | 34.2 | 44.5 | 1.1 | 2.4 | D |
| Example 9 | Example 1 | | | | | | |

As shown in Tables 4 and 5, in Example 10, a stable charge amount is obtained and the environmental variation of the charge amount is small. Additionally, as compared to before the surface oxidation treatment, a high charge amount is attained. On the contrary, in Comparative Example 9, the environmental variation of the charge amount is large, and as compared to before the surface oxidation treatment, no marked change of the charge amount is found.

### Example 11

The ferrite particles (a ferrite carrier core material) obtained in Example 1 in an amount of 100 parts by weight and a condensation-crosslinking silicone resin (weight average molecular weight: about 8000) mainly composed of the T unit and the D unit were prepared; to 5 parts by weight of a solution of the silicone resin (the resin solution concentration was 20%, and hence 1 part by weight in terms of solid content; the diluting solvent: toluene), an aminosilane coupling agent (3-aminopropyltrimethoxysilane) as an amine compound was added in an amount of 10% by weight in relation to the resin solid content; the resulting mixture was mixed and stirred with a universal mixing and stirring machine, and thus the surface of the ferrite carrier core material was coated with the resin while toluene was being evaporated.

After checking that the toluene was sufficiently evaporated, the mixture was continued to be stirred further for 5 minutes to almost completely remove the toluene. Then, the ferrite particles were taken out from the device and transferred into a vessel; the vessel was placed in a hot air heating oven and the ferrite particles were heat treated at 220° C. for 2 hours.

Then, the ferrite particles were cooled down to room temperature, and the ferrite particles in which the resin was cured were taken out, the aggregation of the particles was disintegrated with a vibration sieve of 200M in mesh opening, and the nonmagnetic fractions were removed with a magnetic separator. Successively, the coarse particles were removed, again with a vibration sieve, and thus a resin-coated ferrite carrier was obtained.

### Example 12

By using the ferrite particles (a ferrite carrier core material) subjected to a surface oxidation treatment, obtained in Example 10, a resin-coated ferrite carrier was obtained in the same manner as in Example 11.

### Comparative Example 10

By using the ferrite particles (a ferrite carrier core material) obtained in Comparative Example 1, a resin-coated ferrite carrier was obtained in the same manner as in Example 11.

### Comparative Example 11

By using the ferrite particles (a ferrite carrier core material) obtained in Comparative Example 2, a resin-coated ferrite carrier was obtained in the same manner as in Example 11.

### Comparative Example 12

By using the ferrite particles (a ferrite carrier core material) obtained in Comparative Example 3, a resin-coated ferrite carrier was obtained in the same manner as in Example 11.

### Comparative Example 13

By using the ferrite particles (a ferrite carrier core material) obtained in Comparative Example 7, a resin-coated ferrite carrier was obtained in the same manner as in Example 11.

For each of the resin-coated ferrite carriers obtained in Examples 11 and 12 and Comparative Examples 10 to 13, the charge rise performance (NN environment), the charge amounts (HH environment, NN environment, LL environment), the charge amount ratio and the evaluations are shown in Table 6. The charge rise performance was measured by the below-described method. The measurement of the charge amount was performed as described above. The evaluations were performed on the charge rise performance, the absolute values of the charge amounts and the charge amount ratio (environmental variation). The evaluation methods are the same as described above.

[Charge Rise Performance]

In the NN environment, 88 g of a resin-coated ferrite carrier and 12 g of a commercially available negatively chargeable toner were weighed out, placed in a 100-cc plastic bottle and mixed with a ball mill by 100 rotations in a vertical direction; and the charge amounts at the predetermined elapsed times (1 minute, 3 minutes, 5 minutes, 10 minutes and 30 minutes) were measured by the above-described method, and are presented as indexes with reference to the saturation value of the charge amount taken as 100.

TABLE 6

| | | | | | | | | | | | Evaluations | | |
|---|---|---|---|---|---|---|---|---|---|---|---|---|---|
| | | Properties of resin-coated ferrite carrier | | | | | | | | | | | Charge amount |
| | Ferrite | Charge rise performance | | | | | Charge amount (μC/g) | | | Charge | Charge | Absolute | ratio |
| | carrier | (relative to saturated | | | | | HH | NN | LL | amount | rise | values of | (environmental |
| | core | value taken as 100) NN environment | | | | | environ- | environ- | environ- | ratio | perfor- | charge | variation) |
| | material | 1 min | 3 min | 5 min | 10 min | 30 min | ment | ment | ment | LL/HH | mance | amounts | LL/HH |
| Example 11 | Example 1 | 63 | 94 | 99 | 100 | 87 | 29.8 | 30.6 | 31.2 | 1.0 | A | A | A |
| Example 12 | Example 10 | 75 | 96 | 99 | 100 | 84 | 57.2 | 58.9 | 60.2 | 1.1 | A | A | A |
| Comparative | Comparative | 32 | 58 | 80 | 89 | 100 | 8.8 | 13.2 | 21.2 | 2.4 | D | C | D |
| Example 10 | Example 1 | | | | | | | | | | | | |
| Comparative | Comparative | 25 | 48 | 70 | 90 | 100 | 15.7 | 31.3 | 47.6 | 3.0 | D | A | D |
| Example 11 | Example 2 | | | | | | | | | | | | |
| Comparative | Comparative | 42 | 77 | 87 | 94 | 100 | 3.2 | 7.3 | 8.8 | 2.7 | D | D | D |
| Example 12 | Example 3 | | | | | | | | | | | | |
| Comparative | Comparative | 58 | 89 | 97 | 100 | 78 | 1.0 | 5.2 | 13.0 | 12.5 | B | D | D |
| Example 13 | Example 7 | | | | | | | | | | | | |

As shown in Table 6, Examples 11 and 12 are excellent in the charge rise performance and exhibit high charge amounts in the individual environments and the environmental variations thereof are small. On the contrary, Comparative Examples 10 to 13 are poor in the charge rise performance and also large in the environmental variation of the charge amount. Additionally, Comparative Examples 10, 12 and 13 are low in charge amount.

The ferrite carrier core material for an electrophotographic developer and the ferrite carrier for an electrophotographic developer according to the present invention each have an intended high charge amount, and are each small in the environmental variations of the electric properties including the charge amount. Accordingly, such a ferrite carrier core material and such a ferrite carrier can be widely used as a developer together with a toner as a developer for printing machines such as full color machines required to be high in image quality and high-speed machines required to be satisfactory in the reliability and durability in the image maintenance.

Additionally, by the production method according to the present invention, the ferrite carrier core material and the ferrite carrier can be produced with production stability.

What is claimed is:

1. A ferrite carrier core material for an electrophotographic developer, comprising a ferrite particle having an apparent density of 2.30 to 2.80 g/cm³, a BET specific surface area of 0.09 to 0.70 m²/g and an average degree of circularity of 0.90 or more,
wherein the Cl concentration of the ferrite carrier core material measured by an elution method is 0.1 to 100 ppm.

2. A ferrite carrier for an electrophotographic developer, wherein the surface of the ferrite carrier core material according to claim 1 is coated with a resin.

3. A method for producing a ferrite carrier core material for an electrophotographic developer, by subjecting to thermal spraying in the air a granulated substance obtained by preparing raw materials of the ferrite carrier core material together with a binder, and by rapidly cooling and solidifying the resulting thermally sprayed substance,
wherein the binder is polyvinyl alcohol having a degree of polymerization of 800 to 3000 and a degree of saponification of 75 to 96 mol % and is contained in an amount of 0.5 to 3.5% by weight in terms of the solid content in relation to the granulated substance.

4. A method for producing a ferrite carrier for an electrophotographic developer, wherein the surface of the ferrite carrier core material obtained by the production method according to claim 3 is coated with a resin.

5. An electrophotographic developer comprising the ferrite carrier according to claim 2 and a toner.

6. An electrophotographic developer comprising the ferrite carrier obtained by the production method according to claim 4 and a toner.
